(19) United States
(12) Patent Application Publication
(10) Pub. No.: US 2007/0022856 A1
(43) Pub. Date: Feb. 1, 2007

(54) Miter gauge utilizing parallelogram action

(76) Inventor: Don Paine, Brantford (CA)

Correspondence Address: EDWARD H. OLDHAM, 20 JAMESON DRIVE, DUNDAS, ON, L9H 5A2, CA

(21) Appl. No.: 11/190,959

(22) Filed: Jul. 28, 2005

(51) Int. Cl. B43L 7/10; B26D 7/27

(52) U.S. Cl. 83/522.11; 33/455

(57) ABSTRACT

A mitre angle transferring device comprising two sets of interconnected pivoting arms slidably mounted on a base in the from of a parallelogram. The arms are pivoted by moving a pair of captive pivot assemblies back and forth along a slot in the base. A first pair of the arms is able to gauge and transfer an interior angle to a table or mitre saw, while extension arms on a second set of pivoting arms is able to gauge and transfer an exterior angle to a table or mitre saw. The base of the device is made to be mounted in the guide slot provided in a table or mitre saw.

### BACKGROUND OF THE INVENTION

Mankind has struggled to find a method to conveniently measure the angle at which two surfaces meet, say as two abutting walls of a housing structure where the angle (exterior or interior) is seldom ninety degrees and then having successfully measured the angle, being able to transfer this measured angle to a cutting device be it a saw or a tile cutter etc. for cutting the trim etc. to match the measured angles. In earlier times when a carpenter was faced with the problem of cutting corner trim to match the angle of the corner to which the trim was to be ultimately applied, it was usual to employ some means of measurement of the angle of the abutting walls and after measuring this angle, bisect the measured angle and then draw a pencil line on the trim according to the value of bisected angle and cut the trim along the pencil line.

This procedure has been followed for producing matching trim pieces of abutting trim members for years. The resulting joint may be acceptable depending on the skill of the workman in taking the correct measurements and subsequently marking and cutting the trim.

Various devices have been devised to measure angles existing at the intersection of two surfaces. Some of the devices have applied locking measurement devices to prevent the loss of the measured angle setting stored in the device until the measured angle is no longer needed.

The above procedure has been used in the construction industry for years and skilled artisans have been able to create an acceptable trimmed joint in a very short time.

With the advent of the modern miter saw in which the miter saw blade is capable of being adjusted about two orthogonal axes, more and more trim is being cut using a saw wherein the blade angle is derived from devices used to measure the “miter” angle of a corner. The technique generally requires some intelligent “guesswork” to transfer the existing corner angle to the adjustable mitre saw, but a skilled artisan is generally able to obtain a good miter corner joint if given sufficient time.

### SUMMARY OF THE INVENTION

In accordance with this invention an angle transferring device comprising four interconnected pivoting levers are mounted on an elongated slotted base member. Each lever is provided with two separated points where pivoting is made possible, and the distances between the pivot points for each of the four levers is the same. Thus four levers therefore always form a parallelogram with two opposing apecies of the parallelogram being pivotally mounted on two pivot assemblies located in the slot of the elongated base. The pivot assembles are confined to sliding in motion in a track in the slot of the base member.

The slotted base member is specially made to be of such width to permit it to be used in the standard guide slot found in most table saws (about ¾ of an inch). In the device about to be described a first pair of identical arms are pivotably mounted at a first pivot point located near one of their ends on a first pivot assembly, and a second pair of identical arms (but of differing lengths from that the first pair of arms), are mounted so as to pivot about a second pivot point located at about the mid point of each of the second pair of arms. The opposite ends of the first pair of arms opposite the pivot assembly are attached to the ends of the second pair of arms so as to form a “parallelogram”. By moving the two pivot assemblies in the track of the enclosed slot in the base it will be found that the resulting device is adjustable (by sliding either of the pivot assemblies) to record a “miter” angle existing at the abutment of two surfaces. The device is capable of adjustment which enables it to record angles between about 11 degrees to about 172 degrees. The device may then be locked when the angle has been set on the device and then the recorded (miter) angle may be transferred to an adjustable miter saw directly. Because of the construction of the device the recorded angle of the device is automatically bisected when installed in the track of a miter saw. This permits the correct blade angle of the saw to be set directly from the device of this invention. This feature is made possible by having a convenient “mitre” angle measuring capability, the ability to lock the device once the angle has been set on the device, and slip the device into the slot of the table or mitre saw etc so that the blade angle may be quickly and accurately set to cut a work piece in accordance with the recorded value. The saw will then cut the work piece at the required bisected angle.

### PERTINENT PRIOR ART

U.S. Pat. No. 5,402,701

This device includes a base member on which an adjustable pair of miter arms are pivotably mounted. Although adjustment of the miter arms is described, there is no way of using the miter arms to measure the angle of the corner for which trim is to be cut.

U.S. Pat. No. 4,527,341

This device utilizes a parallelogram principle to ensure that the angle being set will not only be accurate, but will provide the complementary angle to the angle being displayed on the device. Although this device may be used to produce a desired angle or measure an angle existing between two planes, no method of transferring the desired angle to a miter saw etc. is described.

U.S. Pat. No. 1,879,980

This patent describes a miter gauge which uses an intermediary member to assure that the arms defining the bevel angle are properly set. Although the device possesses the capability of measuring some miter angles, no method of transferring the measured angle to a miter saw etc. is discussed.

U.S. Pat. No. 1,181,388

This device is an angle measuring device which uses a parallelogram action to assure that the measured angle may be readily bi-sected or tri-sected. No method of transferring the measured angle or any of the bi-sected or tri-sected angle to a miter saw is discussed.

U.S. Pat. No. 361,243

This invention entitled “BEVEL” is useful in marking stock with various bevel angles. The device is capable of setting angles between five and eighty-five degrees. Note that although one may use this device to measure a corner angle, no mention is made as to how one would transfer this angle to a miter saw etc. to cut trim pieces to the exact corner angle.

### BRIEF DESCRIPTION OF THE DRAWINGS

FIG. 1 is a perspective view of the device of this invention;

FIG. 2 is an exploded view of the device of this invention;

FIG. 3 is a cross sectional view of a pivot mounting, the device of this invention;

FIG. 4 is an exploded view of the pivot assembly of this invention;

FIG. 5 is a plan view of the device of this invention set for a shallow internal angle measurement;

FIG. 6 shows the device where an internal angle of about ninety degrees has been measured;

FIG. 7 shows a plan view of the device of this invention with the adjustable arms located at a different location in the base;

FIG. 8 is a plan view of the device showing a setting for measuring an external angle of about 90 degrees.

### DESCRIPTION OF THE PREFERRED EMBODIMENT

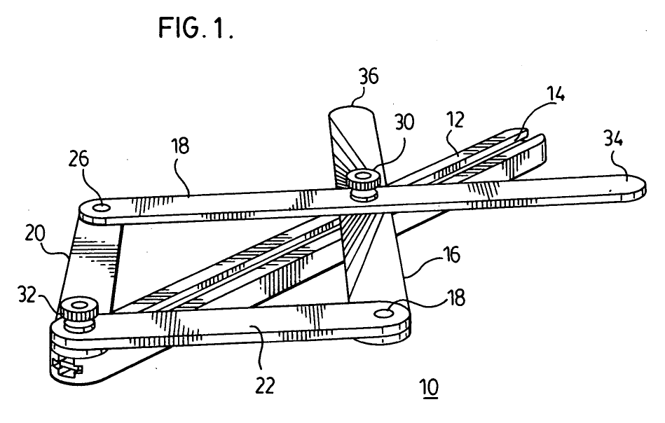

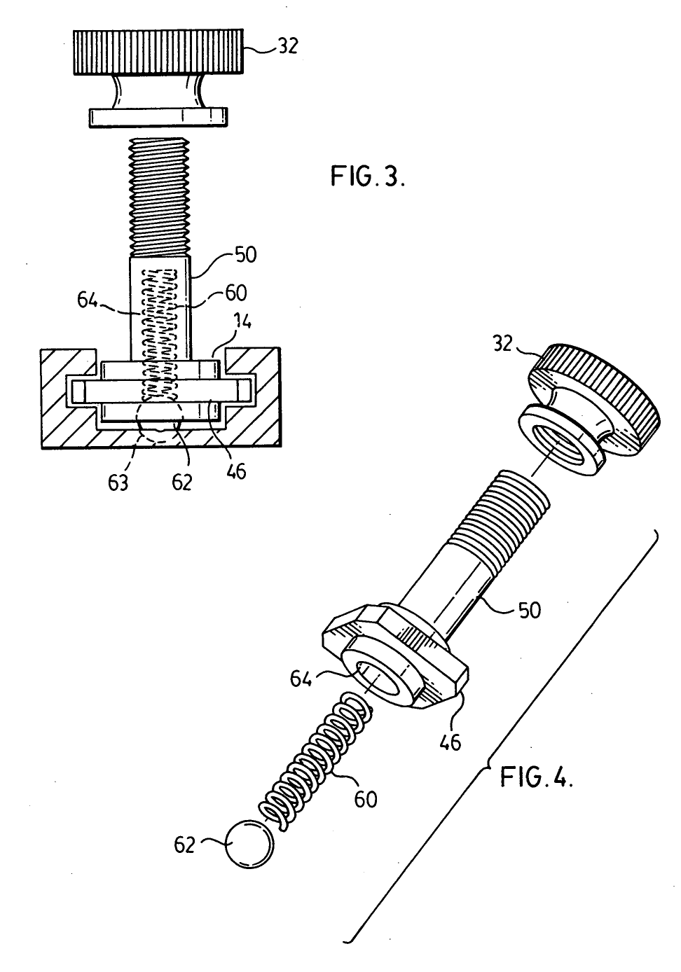

Referring now to the device 10 of FIG. 1, it will be seen that device 10 consists of an elongated base 12 having a shaped slot 14 extending the length of the base. (The shape of slot 14 is best shown in FIG. 3). Two pairs of lever arms, 16, 18, 20 and 22 are pivotally connected together at pivots 26 and 28 and at sliding pivots 30 and 32 which are slidable in slot 14 to permit the respective arms mounted thereon to assume different angular configurations.

It will be seen that arms 20 and 22 are identical in shape size and length and pivots 26, 28 are located in the ends of arms 20 and 22. On the other hand, arms 16 and 18 are also identical but are approximately twice as long as arms 20 and 22. Pivot 30 is located about at the mid point between the ends of each of arms 16 and 18 so that the length of each lever existing between pivots 26, 28, 30 and 32 is made to be equal. The free ends 34 and 36 of levers 16 and 18 extend past the pivot 30 about the same distance as the distances between pivots 26, 28 and 30, 32. The extensions 34 and 36 enable device 10 to measure exterior angles of abutting surfaces.

Base 12 is made to be of such width as to be accepted in the standard recessed groove provided in the table of a table saw or in the standard miter saw guide slot. The slot provided in the tables of most saws is usually about ¾″ wide and this is the width of base 12. Device 10 may therefore be inserted directly into recess in a saw table and may be slid back and forth in a good sliding fit.

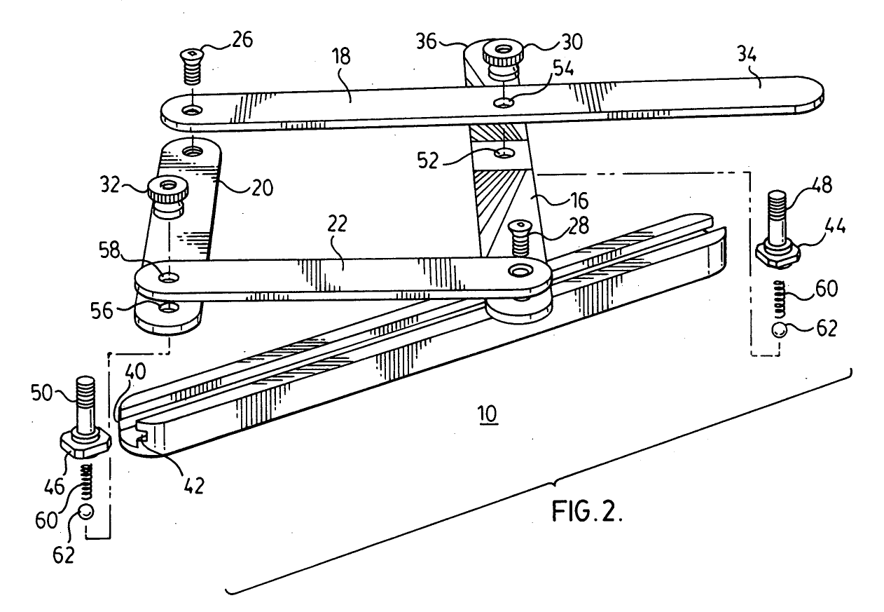

Turning now to FIG. 2 the device shown in FIG. 1 is drawn in an exploded perspective view. Base 10 is shown having slot 14 formed therein. The shape of the track in slot 14 is shown in more detail in FIG. 2 and is made to have a pair of recesses 40 and 42 extending into the sides of slot 14 to receive the heads 44, 46 of bolts 48, 50 of pivots 30, 32 in a captive fashion.

Once inserted into slot 14 the heads 44, 46 engage recesses 40, 42 and bolts 48, 50 may be slid in slot 14 with the heads of bolts 44, 46 remain captive in slot 14.

Bolt 48 is inserted through holes 52, 54 of levers 16, 18 and nut 30 of the pivot assembly is threaded on to bolt 48 to hold levers 16, 18 in a predetermined pivoting working relationship on base 12.

Similarly bolt 50 passes through holes 56, 58 of levers 20, 22 and nut 32 of the pivot assembly holds the ends of levers 20, 22 in a predetermined pivoting relationship on base 12.

Bolts 48 and 50 have a hollow bore 64 extending into the shaft of bolts 48, 50 to accommodate springs such as 60 and balls such as 62 in bore 64 as shown in FIG. 3. Spring 60 is provided to spring load ball 62 in slot 14 to prevent free motion of pivots 30 and 32 during a corner measuring operation.

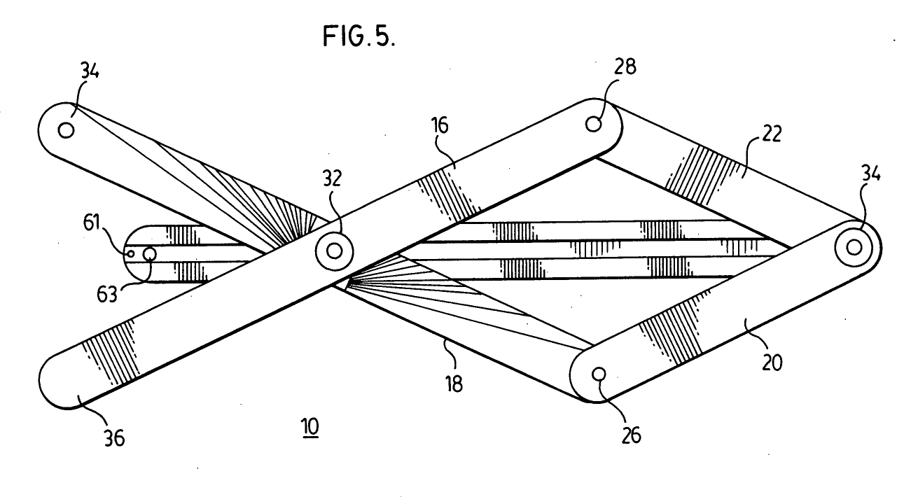

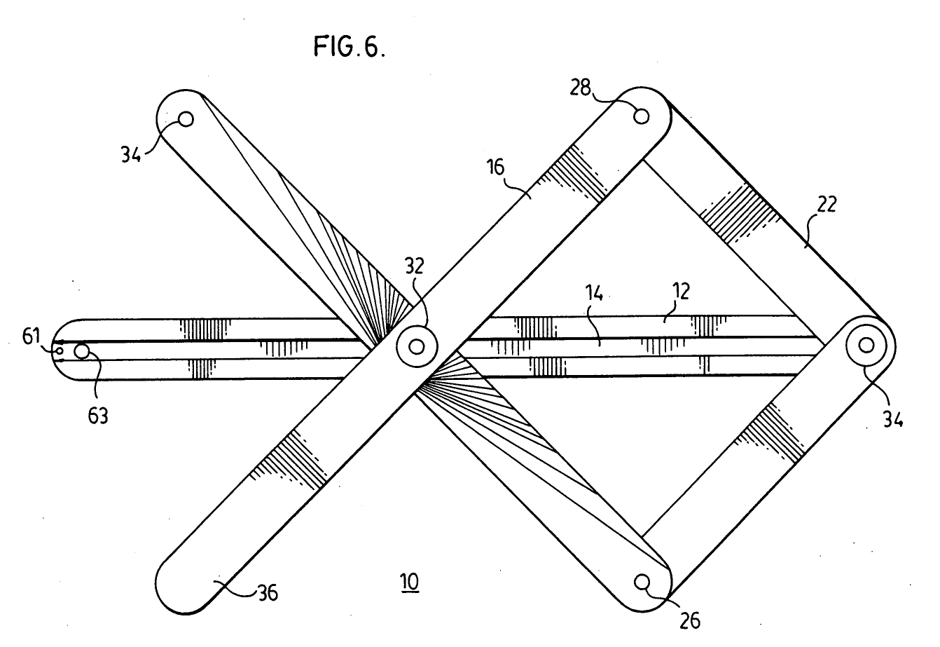

FIGS. 5, 6, 7 and 8 show the device 10 in various configurations used for measuring and transferring measured angles to a saw.

FIG. 5 shows device 10 set after measuring an interior corner angle with levers 20, 22. Pivots 32 and 34 will be locked to maintain the angle setting captured by device 10. The device may be slid into a guide slot of a table or mitre saw to adjust the guide stop or the blade position of the mitre saw to the angle transferred by device 10.

FIG. 6 shows the setting of device 10 to measure an interior angle of about 90 degrees (shown by levers 20, 22).

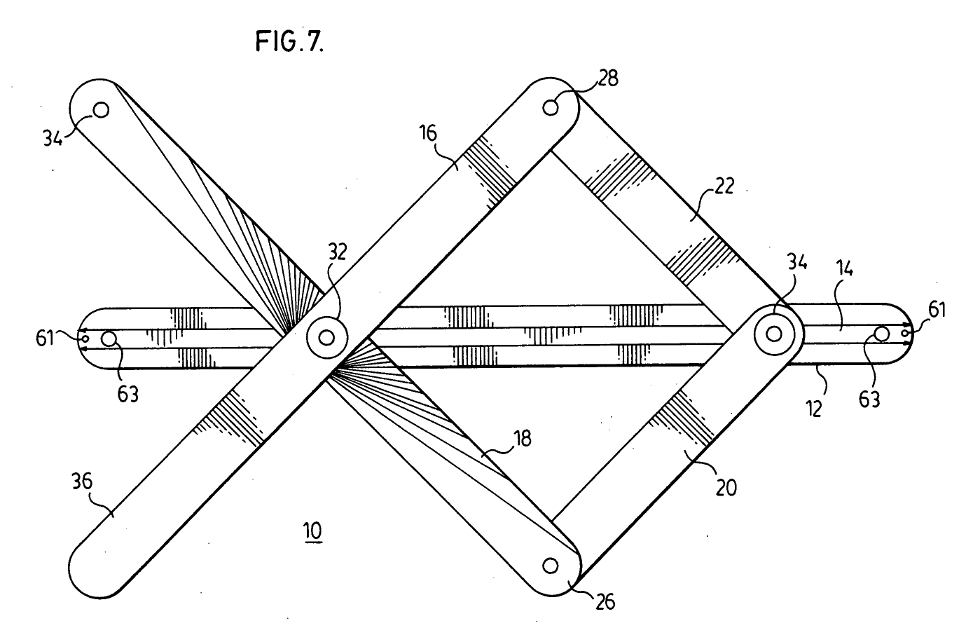

FIG. 7 shows the device 10 with pivots 32, 34 located at points intermediate the ends of base 12.

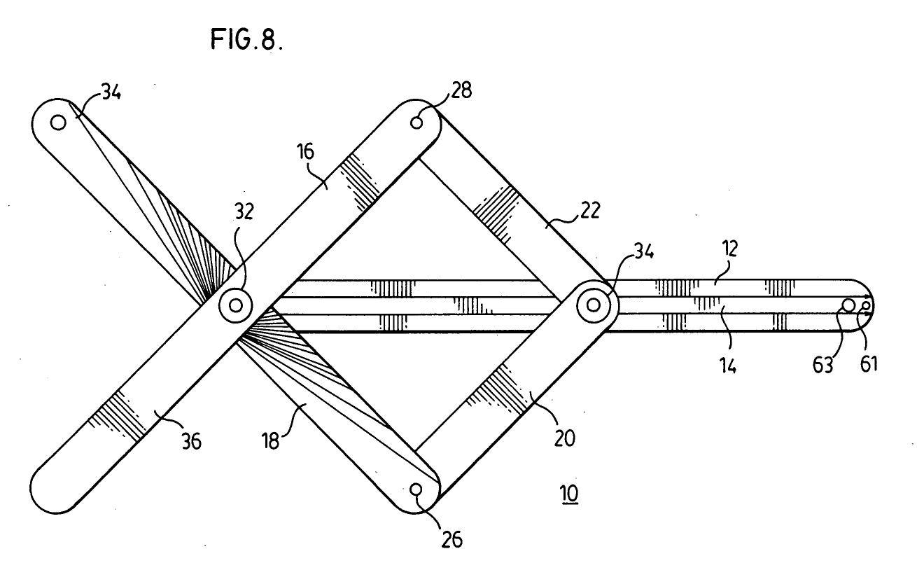

FIG. 8 shows the setting of device 10 for measuring an external angle subtended by lever extension 34, 36. As mentioned previously the angle value set on device 10 may be directly transferred to a table or mitre saw by device 10 without having to know the exact value of the measured angle.

The slot 14 is usually provided with end stops 61 at each end of slot 14 to prevent bolts 48 and 50 from sliding past the ends of the slot 14 in base 12. Slot 14 is also provided with two dimples 63 (See FIG. 3) at each end of slot 14 to provide a precise location for setting the miter device 10 when measuring corner angles.

The spring loaded balls 62 are provided to add a controlled amount of resistance to motion of the lever assemblies during an angle measurement operation.

In this instance the levers 20, 22 are shown of equal length and equal to the lengths of levers 16 and 18 between pivots 30, 26 and 30, 28.

It is not absolutely necessary that these distances be equal as shown in this description, but it is essential that levers 20, 22 be of equal length, and that the portions of levers 16 and 18 between pivots 30, 28 and pivots 30, 26 be of equal length.

Other changes will be obvious to those skilled in the art, however applicant wishes to restrict the coverage of his invention to the invention as defined in the following claims.

What is claimed:

1. An adjustable miter gauge comprising:
a slotted elongated base member, and two pairs of arms pivotally connected to form an adjustable parallelogram, said arms being provided with sliding pivots located at opposing apecies of said parallelogram which are captively mounted for sliding action in the slot of said base member,
said sliding pivots being lockable at predetermined positions in said base member,
a first of said pairs of arms being substantially longer than the other pair of arms, said first of said pairs of arms having extensions extending beyond the sliding pivot connecting said first of said pairs.

2. An adjustable miter gauge as claimed in claim 1 where said first of said pairs is substantially twice the length of said other pair of arms.

3. An adjustable miter gauge as claimed in claim 1 wherein said sliding pivot of said first pair of arms is located at substantially the mid point of said arms.

4. An adjustable miter gauge in which said base member is of a width to slidingly fit into the slot provided in the tables of most miter saws.

5. An adjustable miter gauge as claimed in claim 1 wherein said slot is provided with stops to prevent said sliding pivots from escaping from the ends of said slot.

6. An angle measuring and storing device having four levers having points for pivotal motion provided at predetermined locations on said levers such that the distance between the pivots on each lever is “X”, a first pair of said four levers being of an equal first length, and a second pair of said four levers being of an equal length but different from said first length,
both pairs of levers having first points of pivotal motion located near a first end of said levers, said first pair of levers having a second set of poinds for pivotal motion located at a distance “X” from said first points of pivotal motion remote said first points of pivotal motion on each lever,
said second pair of levers being pivotally attached to said first pair of levers at said second set of points for pivotal motion, said second pair of levers having a third points of pivotal rotation at a distance “X” from said second points of pivotal rotation,
both pairs of levers being mounted on an elongated base of a predetermined shape, said base being provided with a slotted recess having a track therein extending the length of said base, for capturing a pair of pivot assemblies mounted in a sliding relationship in said slotted recess,
a first of said pivot assemblies passing through the first points of pivotal motion of said first pair of levers,
a second of said pivot assemblies passing through said third points of pivotal motion of said second pair of levers,
said second set of points for pivotal motion of said first pair of levers and said first set of points for pivotal motion of said second pair of levers being connected together in a pivoting relationship.

7. A device as claimed in claim 6 wherein each pivot assembly is provided with a frictional element to engage said slotted recess.

8. A device as claimed in claim 6 wherein said frictional element is a spring loaded ball.

9. A device as claimed in claim 6 wherein said base has a width corresponding to the width of a slotted track provided for a guide in a table saw.
